(19) United States
(12) Patent Application Publication
(10) Pub. No.: US 2009/0169859 A1
(43) Pub. Date: Jul. 2, 2009

(54) Article Comprising a Mesoporous Coating Having a Refractive Index Profile and Methods for Making Same

(75) Inventors: John Biteau, St-Petersburg, FL (US); Jean-Pierre Boilot, Charenton-Le-Pont (FR); Mamonjy Cadet, Charenton-Le-Pont (FR); Hervé Cado, Charenton-Le-Pont (FR); Thierry Gacoin, Charenton-Le-Pont (FR); Muriel Matheron, Charenton-Le-Pont (FR); Philippe Roisin, Charenton-Le-Pont (FR); Laurianne Vagharchakian, Charenton-Le-Pont (FR)

Correspondence Address: FULBRIGHT & JAWORSKI L.L.P., 600 CONGRESS AVE., SUITE 2400, AUSTIN, TX, 78701, US

(73) Assignee: Essilor International (Compagnie Generale d'Optique), Charenton Le Pont (FR)

(21) Appl. No.: 12/278,133

(22) PCT Filed: Feb. 2, 2007
(86) PCT No.: PCT/FR07/50743

§ 371 Date: Aug. 1, 2008

(30) Foreign Application Priority Data
Feb. 2, 2006 (FR) 0650381

(51) Int. Cl. B32B 3/26; B05D 5/00

(52) U.S. Cl. 428/304.4; 427/256

(57) ABSTRACT

The present invention relates to an article comprising a substrate having a main surface coated with a coating, part of which at least is mesoporous and has a refractive index profile with optical function, whose variation is imposed by the mesopore content and/or the filling ratio of the mesopores.

The profile may be such that the refractive index varies depending on the distance to a given axis, or such that the refractive index variation is monotone, decreasing along any axis which is perpendicular to the surface of the substrate underlying the mesoporous part of said coating and oriented away from the substrate.

The present invention also relates to methods for making said article, which differ depending on the technique from which the refractive index profile is created.

The invention is applicable to ophthalmic optics.

The present invention generally relates to articles coated with a mesoporous sol-gel coating having a refractive index profile, such as for example optical lenses or optical fibers, preferably made of plastic material, and more particularly to such transparent articles having a low chromatic aberration, as well as to their production methods.

An optical article is characterized by its geometry, its thickness and its refractive index. The latter is often homogeneous. A refractive index profile in an optical material, for example a refractive index gradient, does impart an additional degree of freedom as regards the use of said article. Indeed, the refractive index profile enables to vary the optical path of rays, independently from the article geometry.

Producing optical articles comprising a coating having a refractive index profile especially aims at providing simplified optical systems for a performance similar to that of systems composed of optical elements having homogeneous indexes. Such a production enables to develop for example optical systems comprising a plurality of elements whose number could thus be reduced, or to develop corrective glasses or lenses which would be thinner and/or would have a simplified geometry.

Some methods are known from the state of the art for making optical articles having a refractive index profile, especially a radial index gradient. These articles may especially be obtained by controlled diffusion/polymerization or swelling of a mixture of monomers selected depending on their refractive index, such as described in the patent applications EP 0407294, FR 2762098 or EP 0504011.

The applicant has developed a new category of materials having a refractive index profile, thanks to the use of mesoporous layers.

It is an object of the present invention to provide an article comprising a substrate onto which is deposited a coating comprising one or more mesoporous sol-gel layers having a low refractive index, that is to say a refractive index n≦1.50 (λ=633 nm, T=20-25° C.), arranged so as to create a continuous or a discontinuous refractive index profile, and particularly an optical or an ophthalmic lens or an optical fiber.

It is a further object of the present invention to provide methods for making the hereabove article, which differ depending on the technique from which the refractive index profile is created.

The present invention is particularly interesting in the optical field, where substrates made of organic materials are often used, especially transparent organic substrates such as optical or ophthalmic lenses. Yet, a traditional method for removing the pore-forming agents, described for example in the patents WO 03/024869, U.S. Pat. No. 5,858,457 and US 2003/157311, consists in submitting a substrate coated with a mesostructured film to a high temperature calcination (350-500° C.), generally under an oxygen or an air flow, sometimes for several hours.

Therefore it would be desirable to have a method for making mesoporous films, based on the removal of the pore-forming agent under mild conditions, because methods which do imply a calcination step are not suitable for treating organic substrates which would be damaged by the calcination high temperatures. In addition, exposing mesostructured films to high temperatures may cause the structure to collapse due to the high deformations resulting from these treatments.

A further drawback of such methods which do imply a calcination is a high energetic expenditure, which makes expensive these methods for making mesoporous films.

It is therefore another object of the present invention to provide methods for making coatings having a refractive index profile such as hereabove, which may apply to any type of substrate and especially to heat-sensitive, transparent substrates made of organic materials.

First, the present invention relates to an article comprising a substrate having a main surface covered with a coating, part of which at least is mesoporous, said mesoporous part having a refractive index profile with optical function, whose variation is imposed by the mesopore content and/or the filling ratio of the mesopores.

The refractive index profile of the coating of the invention has a very wide-ranging optical function. This may be, without limitation, a coating having an antireflective function, a coating whose refractive index profile enables to impose a power profile within a localized area of the article, a coating whose refractive index profile enables to impose a power profile corresponding to a near vision correction, or a coating whose refractive index profile enables to correct aberrations. Said interesting profile may especially be a gradient.

According to the invention, a refractive index profile may be obtained by creating a porosity profile when removing the pore-forming agent from the precursor layers of the mesoporous layers.

According to one preferred embodiment of the invention, the refractive index profile is a radial profile, and preferably a radial gradient. With a radial profile, the index varies depending on the distance to a given axis.

This type of profile may be obtained, at least locally, by modulating the removal of the pore-forming agent along an axis which is perpendicular to the optical axis. The axis related to which the radial profile is defined is preferably the optical axis of the article, but it may also be an axis which is parallel to the optical axis.

A radial profile may be obtained by removing the pore-forming agent using a degradation method, having used a masking system, enabling for example to regulate the ozone/UV amount reaching the surface and thus to control the degradation extent of the pore-forming agent and the filling ratio of the mesopores.

In a second preferred embodiment of the invention, the refractive index variation is monotone, decreasing along any axis which is perpendicular to the surface of the substrate underlying the mesoporous part of said coating and oriented away from the substrate. As opposed to the “radial” profile hereabove described, such profile may be defined as an “axial” profile.

Such a profile may be obtained by depositing onto a substrate a stack of mesoporous films made from a composition having a variable content of a pore-forming agent, or by partially removing the pore-forming agent in a given direction of a mesoporous film or of a stack of mesoporous films, or by combining both methods, so as to create in each case a refractive index profile whose orientation is perpendicular to the surface of the substrate underlying the mesoporous part of the film, the index decreasing in the substrate →mesoporous film direction.

According to the present invention, it is possible to cumulate both an “axial” and a “radial” refractive index profile, or to have only one of these profiles.

The present invention will be described in more detail with reference to the appended drawings, wherein:

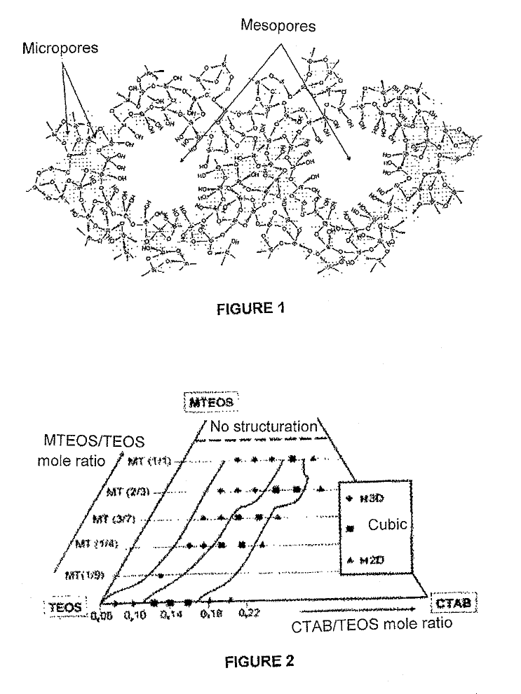

FIG. 1 is a schematic view of the morphology of a silica matrix-based mesoporous film obtained after removal of the pore-forming agent.

FIG. 2 shows part of the ternary phase diagram of TEOS/MTEOS/CTAB films, what makes it possible to determine the ordered, or not, structure of a film of the invention prepared from the pore-forming agent CTAB, the inorganic precursor agent TEOS and the hydrophobic precursor agent MTEOS. The nature of these compounds is detailed in the following description.

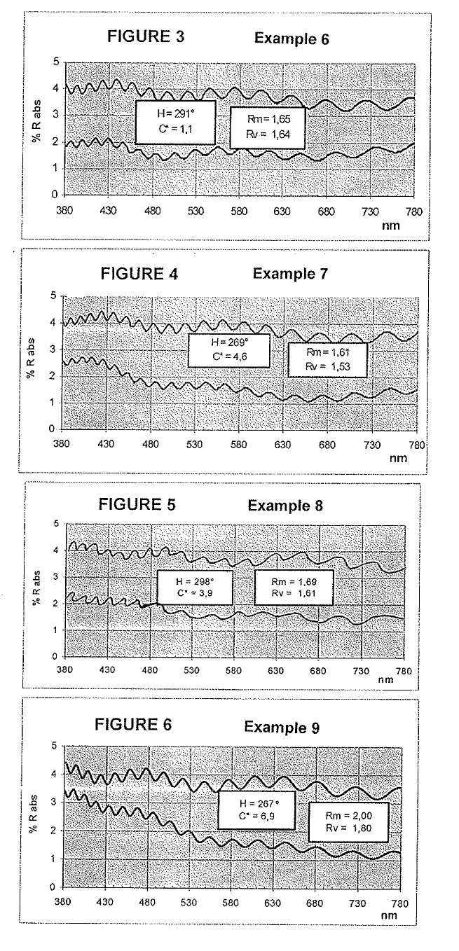

FIGS. 3 to 6 show the variation vs. wavelength of the reflection coefficient of optical articles coated with a mesoporous film of the invention.

According to one preferred embodiment of the invention, the mesoporous part of the coating of the invention is structured, and the optionally non mesoporous part of the coating of the invention is mesostructured.

In the present application, mesoporous materials are defined as being solids comprising in their structure pores with a size ranging from 2 to 50 nm, which are called mesopores. Such pores are half way in size between macropores (size >50 nm) and micropores from materials of the zeolite type (size <2 nm). These definitions do comply with those given in the IUPAC Compendium of Chemistry Terminology, 2^{nd} Ed., A. D. McNaught and A. Wilkinson, RSC, Cambridge, UK, 1997.

The mesopores may be void, that is to say filled with air, or only partially void. The mesopores are generally randomly distributed within the structure, with a large size distribution. In the present invention, the mesoporous part of a coating means the part from which the pore-forming agent has been at least partially removed.

Mesoporous materials and their preparation have been extensively described in the literature, especially in Science 1983, 220, 365371 or in The Journal of Chemical Society, Faraday Transactions 1985, 81, 545-548.

The article of the invention comprises a substrate having a main surface covered with a coating, part of which at least is mesoporous, what means that at least one localized area of said coating is mesoporous at least until a certain depth.

In the present application, structured materials are defined as being materials having an organized structure, more specifically characterized by the existence of at least one diffraction peak in a diffraction pattern of X-rays or neutrons. The diffraction peaks which are observed in these diagram types may be associated with a repetition of a distance which is characteristic of the material, called spatial repetition period of the structured system.

In the present application, a mesostructured material is defined as being a structured material having a spatial repetition period ranging from 2 to 50 nm.

Structured mesoporous (or ordered mesoporous) materials belong to a particular class of mesostructured materials, which are mesoporous materials having an organized spatial arrangement of the mesopores which are included within their structure, therefore resulting in a spatial repetition period.

The usual method for preparing optionally structured, mesoporous films consists in preparing a poorly polymerized sol from an inorganic material such as silica, based on a precursor such as a tetraalkoxysilane, in particular tetraethoxysilane (TEOS), such a sol also comprising water, a generally polar, organic solvent such as ethanol, and a pore-forming agent, most often in an acidic medium.

When the pore-forming agent is an amphiphilic agent, for example a surfactant, it acts as a structuring agent and generally leads to structured materials, which will be explained hereafter.

The surfactant concentration in the solution is, prior to depositing, significantly lower than the critical micelle concentration. This sol is then deposited onto a substrate. During such deposition, the organic solvent does evaporate, thus increasing the water, surfactant and silica content in the film, whereby the critical micelle concentration is reached. As the solvent medium is highly polar, the surfactant molecules do aggregate, thus forming micelles orienting their polar heads towards the solvent.

The inorganic lattice (for example silica) develops then and, due to its highly polar character, does form a matrix around the micelles. Composite species are therefore produced, composed of organic micelles coated with mineral precursors. Said lattice expands and does entrap or encapsulate the micelles inside the solid structure.

In a second stage, as evaporation goes on, the micelle shape may optionally change and the micelles self-organize in more or less ordered structures, forming for example a hexagonal, cubic or lamellar lattice, until the film is dry.

The final arrangement of the resulting mineral matrix is governed by the shape of the micelles generated by the used amphiphilic molecules.

The pore size in the final material depends on the size of the pore-forming agent which is entrapped or encapsulated inside the silica lattice. When a surface active agent (surfactant) is used, the pore size in the solid is relatively large as the silica lattice is built up around the micelles, that is to say the colloidal particles, generated by the surfactant. Intrinsically, micelles are larger in size as compared to their components, so that using a surfactant as a pore-forming agent does generally produce a mesoporous material.

When the pore-forming agent is not an amphiphilic agent, there are no micelles formed in the reaction conditions and no structured materials produced.

Once the inorganic lattice is formed around the pore-forming agent-containing mesopores, this pore-forming agent may optionally be removed from the material, whereby a mesoporous material is obtained.

In the present application, a material may be considered as being mesoporous provided the pore-forming agent used for its preparation has been at least partially removed from at least part of this material, that is to say at least one part of this material comprises at least partially void mesopores.

Removing the pore-forming agent may be performed by calcination (heating to a temperature generally of about 400° C.), or using milder methods (solvent, supercritical fluid, UV/ozone or plasma extraction methods).

Instead of silica, other inorganic materials may be used, such as for example metal or metalloid oxide precursors, especially based on titanium, niobium or aluminum.

The present patent application relates to two methods for making an article comprising a substrate having a main surface covered with a coating, part of which at least is mesoporous and has a refractive index profile such as hereabove defined, decreasing away from the substrate.

The first method for making the article comprises at least the following steps:
a) providing a substrate;
b) preparing a precursor sol of a mesoporous film comprising at least one inorganic precursor agent, at least one pore-forming agent, at least one organic solvent, water and optionally a catalyst for hydrolyzing the inorganic precursor agent;
c) depositing a film of the precursor sol prepared in the previous step onto a main surface of the substrate;
d) optionally, consolidating the film deposited in the previous step;
e) partially removing the pore-forming agent from at least part of the coating comprising the film deposited in step c) so as to create in said part of the coating a refractive index gradient which is perpendicular to the surface of the substrate underlying said part of the coating and directed towards the surface of said coating which is the closest to the substrate;
f) recovering a substrate having a main surface covered with a coating, part of which at least is mesoporous.

The second method for making the article comprises at least the following steps:
a) providing a substrate;
b) preparing a precursor sol of a mesoporous film comprising at least one inorganic precursor agent, at least one pore-forming agent, at least one organic solvent, water and optionally a catalyst for hydrolyzing the inorganic precursor agent;
c) depositing a film of the precursor sol prepared in the previous step onto a main surface of the substrate;
d) optionally consolidating the film deposited in the previous step;
e) depositing onto the film resulting from previous step a film of a precursor sol of a mesoporous film comprising at least one inorganic precursor agent, at least one pore-forming agent, at least one organic solvent, water and optionally a catalyst for hydrolyzing the inorganic precursor agent;
f) optionally consolidating the film deposited in the previous step;
g) optionally repeating steps e) and f) at least once;
h) removing the pore-forming agent at least partially from at least part of the coating comprising the films deposited in steps c), e) and if present g);
i) recovering a substrate having a main surface coated with a multilayered coating, part of which at least is mesoporous and has a refractive index profile decreasing away from the substrate along any axis which is perpendicular to the surface of the substrate underlying said mesoporous part of said coating,
   said method being characterized in that in each step e), the pore-forming agent represents a higher percentage of the precursor sol total mass as compared to that of the pore-forming agent in the precursor sol used to make the film obtained in the previous step.

The steps which are common to both methods will first be described.

The article of the invention comprises a substrate onto which the coating is deposited, part of which at least is mesoporous and has a refractive index profile such as hereabove defined. Said coating may comprise a film, part of which at least is mesoporous or a stack of several films. The coating (or the film), part of which at least is mesoporous, will hereafter generally be simply called “mesoporous coating” (or film).
The substrate onto which the films are deposited may be made of any solid, transparent or non transparent material, such as a mineral glass, a ceramics, a glass-ceramics, a metal or an organic glass, for example a thermoplastic or thermosetting plastic material. Preferably, the substrate is made of a transparent material, preferably a transparent organic material.

Thermoplastic materials which may be suitably used for the substrates include (meth)acrylic (co)polymers, in particular polymethyl methacrylate (PMMA), thio(meth)acrylic (co)polymers, polyvinyl butyral (PVB), polycarbonates (PC), polyurethanes (PU), polythiourethanes, polyol allylcarbonate (co)polymers, ethylene and vinyl acetate thermoplastic copolymers, polyesters such as polyethylene terephthalate (PET) or polybutylene terephthalate (PBT), polyepisulfides, polyepoxides, polycarbonates and polyesters copolymers, cycloolefin copolymers such as ethylene and norbornene or ethylene and cyclopentadiene copolymers, and combinations thereof.

As used herein, a “(co)polymer” is intended to mean a copolymer or a polymer. As used herein, a “(meth)acrylate” is intended to mean an acrylate or a methacrylate.

The preferred substrates of the invention include substrates obtained by polymerizing alkyl (meth)acrylates, in particular C₁-C₄ alkyl (meth)acrylates such as methyl (meth)acrylate and ethyl (meth)acrylate, polyethoxylated aromatic (meth)acrylates such as polyethoxylated bisphenol di(meth)acrylates, allyl derivatives such as linear or branched, aliphatic or aromatic polyol allylcarbonates, thio(meth)acrylates, episulfides, and polythiols and polyisocyanates precursor mixtures (to produce polythiourethanes).

Examples of polyol allylcarbonate (co)polymers include (co)polymers of ethylene glycol bis(allylcarbonate), diethylene glycol bis(2-methyl allylcarbonate), diethylene glycol bis(allylcarbonate), ethylene glycol bis(2-chloro allylcarbonate), triethylene glycol bis (allylcarbonate), 1,3-propane diol bis(allylcarbonate), propylene glycol bis(2-ethyl allylcarbonate), 1,3-butene diol bis(allylcarbonate), 1,4-butene diol bis(2-bromo allylcarbonate), dipropylene glycol bis(allylcarbonate), trimethylene glycol bis(2-ethyl allylcarbonate), pentamethylene glycol bis(allylcarbonate), isopropylene bisphenol A bis (allylcarbonate).

Particularly recommended substrates are substrates obtained by (co)polymerizing the diethylene glycol bis(allylcarbonate), sold, for example, under the trade name CR 39® by the PPG Industries company (ORMA® lenses from ESSILOR).

Particularly recommended substrates further include substrates obtained by polymerizing thio(meth)acrylic monomers, such as those described in the French patent application FR 2734827, and polycarbonates.

Of course, the substrates may be obtained by polymerizing mixtures of the hereabove mentioned monomers, or they even may comprise mixtures of these polymers and (co)polymers.

Preferably, all the steps of the first and second methods of the invention are conducted at a temperature ≦150° C., preferably ≦130° C., more preferably ≦120° C. and even more preferably ≦110° C. Thus, these methods are compatible with organic substrates.

The mesoporous coating having a refractive index profile of the invention may be formed onto a main surface of a bare substrate, that is to say an uncoated substrate (non varnished), or onto a main surface of an already coated substrate having one more functional coatings.

Preferably, the substrate of the invention is a substrate for an ophthalmic lens. In ophthalmic optics, it is well known to coat a main surface of a substrate made of a transparent organic material, for example an ophthalmic lens, with one or more functional coatings to improve the optical and/or mechanical properties of the final lens. Therefore, the substrate main surface may be beforehand provided with a primer coating improving the impact resistance (impact-resistant primer coating) and/or the adhesion of the subsequent layers in the final product, with an abrasion-resistant and/or scratch-resistant coating (hard coat), with a polarizing coating, with a photochromic coating, with a coloured coating, with a monolayered or multilayered antireflective coating, or with a stack of at least two of such coatings.

The primer coating improving the impact resistance may be any impact-resistant primer coating layer traditionally used for transparent polymer material articles, such as ophthalmic lenses.

The preferred primer coating compositions include, for example, thermoplastic polyurethane-based compositions, such as those described in the Japanese patents JP 63-141001 and JP 63-87223, poly(meth)acrylic primer coating compositions, such as those described in the patent U.S. Pat. No. 5,015,523, thermosetting polyurethane-based compositions, such as those described in the patent EP 0 404 111 and poly(meth)acrylic latex-based or polyurethane type latex-based compositions, such as those described in the patents U.S. Pat. No. 5,316,791 and EP 0 680 492.

Preferred primer coating compositions include polyurethane-based compositions as well as latex-based compositions, particularly polyurethane type latex-based compositions.

Poly(meth)acrylic latices are latices of copolymers mostly composed of a (meth)acrylate, such as for example ethyl, butyl, methoxyethyl or ethoxyethyl (meth)acrylate, with a generally minor amount of at least one additional comonomer, such as for example styrene.

Preferred poly(meth)acrylic latices include acrylate and styrene copolymers latices. Such acrylate and styrene copolymers latices are commercially available from the ZENECA RESINS company under the trade name NEOCRYL®.

Polyurethane type latices are also known and commercially available. Polyurethane type latices comprising polyester moieties may be mentioned as an example. Such latices are also marketed by the ZENECA RESINS company under the trade name NEOREZ® and by the BAXENDEN CHEMICALS company under the trade name WITCOBOND®.

The impact-resistant primer coating may be a high refractive index primer coating, that is to say having a refractive index higher than or equal to 1.5, or even higher than or equal to 1.6.

The refractive index of the primer coating compositions may be adapted depending on the refractive index of the substrate.

In particular, for substrates having a high refractive index, the refractive index of the primer coating may be adjusted by adding to the primer coating composition mineral fillers having a high refractive indices, such as metal oxides (TiO₂, Sb₂O₅, SnO₂, . . . ), optionally metal oxide composites.

Mixtures of these latices may also be used in the primer coating compositions, in particular mixtures of polyurethane type latex and poly(meth)acrylic latex.

These primer coating compositions may be deposited onto the article sides by dipping or spin-coating, then they may be dried at a temperature of at least 70° C. and up to 100° C., preferably of about 90° C., for a time period ranging from 2 minutes to 2 hours, generally of about 15 minutes, so as to form primer coating layers, each having a thickness after curing ranging from 0.2 to 2.5 μm, preferably from 0.5 to 1.5 μm.

Abrasion-resistant and/or scratch-resistant coatings are preferably hard coatings based on poly(meth)acrylates or silicones. Hard abrasion-resistant and/or scratch-resistant coatings recommended in the present invention include coatings obtained from silane hydrolyzate-based compositions, in particular epoxysilane hydrolyzate-based compositions such as those described in the French patent application FR 2702486 and in the American patents U.S. Pat. No. 4,211,823 and U.S. Pat. No. 5,015,523.

Abrasion-resistant and/or scratch-resistant coatings may be coatings having a high refractive index, that is to say a refractive index higher than or equal to 1.5, or even higher than or equal to 1.6.

As is well known from the man skilled in the art, colloidal fillers may be added to the abrasion-resistant and/or scratch-resistant coating compositions, particularly metal oxides such as those previously mentioned for primer coatings, so as to increase the refractive index of the abrasion-resistant and/or scratch-resistant coatings.

A preferred abrasion-resistant and/or scratch-resistant coating composition is the one disclosed in the patent FR 2702486 in the name of the applicant. It comprises an epoxy trialkoxysilane and dialkyl dialkoxysilane hydrolyzate, colloidal silica and, in a catalytic amount, an aluminum-based curing catalyst such as aluminum acetylacetonate, the rest being substantially composed of solvents traditionally used for formulating such compositions. Preferably, the hydrolyzate used is a γ-glycidoxypropyl trimethoxysilane (GLYMO) and dimethyl diethoxysilane (DMDES) hydrolyzate.

In preferred embodiments of the invention, the mesoporous coating having a refractive index profile, acting as an antireflective coating, is deposited onto a substrate coated successively with an impact-resistant primer coating layer, than with an abrasion-resistant or a scratch-resistant coating, or onto a substrate directly coated with an abrasion-resistant and/or scratch-resistant coating.

The surface of the article onto which will be deposited the expected mesoporous coating having a refractive index profile may optionally be submitted to a pretreatment intended to improve the adhesion of such a coating. The pretreatments which may be considered include corona discharge, plasma under vacuum, ion beam or electron beam treatments, as well as treatments using an acid or a base.

Step b) of the methods of the invention is a step of preparing a precursor sol of a mesoporous film.

Precursor sols of mesoporous films are well known from the state of the art. In the present invention, they comprise at least one inorganic precursor agent or a hydrolyzate thereof, at least one pore-forming agent, at least one organic solvent, water, and optionally a catalyst for hydrolyzing the inorganic precursor agent.

According to the invention, the precursor sol of a mesoporous film may be obtained by dissolving at least one inorganic precursor agent and at least one pore-forming agent in a mixture of water and organic solvent, generally in a water-alcohol medium. In some cases, a heating may be conducted to help dissolving the various compounds. Once all the components have been dissolved, the sol, if necessary, is cooled and stirred under conditions which are sufficient (under heating if required) to enable a co-condensation of the precursors and optionally the formation, prior to depositing, of colloidal particles comprising the pore-forming agent dispersed within the developing lattice. The sol is then ready to be deposited as a film onto the main surface of the substrate. It should be noted that in the case of a pore-forming agent of the surfactant type, the formation of the colloidal particles (micelles) does occur during the deposition step.

As used herein, an “inorganic precursor agent” is intended to mean an organic or inorganic agent which, if polymerized alone, would produce an inorganic matrix.

The inorganic precursor agent is preferably selected from organometallic or organometalloid compounds and mixtures thereof of formula:

M(X)₄ (I)

wherein M is a tetravalent metal or metalloid, preferably silicon, and the X groups, being the same or different, are hydrolyzable groups preferably selected from alkoxy, acyloxy and halogen groups, preferably alkoxy groups.

Tetravalent metals corresponding to M include for example metals such as Sn or transition metals such as Zr, Hf or Ti. M is preferably silicon and if so, the compound (I) is the precursor of a silica-based matrix or of a matrix based on at least one metal silicate.

Amongst the X groups, —O—R alkoxy groups are preferably C₁-C₄ alkoxy groups, —O—C(O)R acyloxy groups are preferably groups, wherein R is an alkyl radical, preferably a C₁-C₆ alkyl radical such as a methyl or an ethyl radical, and halogens are preferably Cl, Br or I. Preferably, the X groups are alkoxy groups, and particularly methoxy or ethoxy groups, and more preferably ethoxy groups, what makes the inorganic precursor agent (I) a metal or a metalloid alcoholate.

When a catalyst for hydrolyzing the inorganic precursor agent is used, it acts as a condensation catalyst by catalyzing the hydrolysis of the X groups of the compound of formula (I).

Preferred compounds (I) are tetraalkyl orthosilicates. Amongst them, tetraethoxysilane (or tetraethyl orthosilicate) Si(OC₂H₅)₄ noted TEOS, tetramethoxysilane Si(OCH₃)₄ noted TMOS, or tetrapropoxysilane Si(OC₃H₇)₄ noted TPOS are advantageously used, and TEOS is preferably used.

The inorganic precursor agents included in the sol generally represent from 10 to 30% by mass as related to the precursor sol total mass.

The organic solvents or the mixture of organic solvents to be suitably used for preparing the precursor sol according to the present invention are all classically used solvents and more particularly polar solvents, especially alkanols such as methanol, ethanol, isopropanol, isobutanol, n-butanol and mixtures thereof. Other solvents, preferably water-soluble solvents, may be used, such as 1,4-dioxane, tetrahydrofurane or acetonitrile. Ethanol is the most preferred organic solvent.

Generally speaking, the organic solvent represents from 40 to 90% by mass as related to the precursor sol total mass.

Water included in the precursor sol generally represents from 10 to 20% by mass as related to the precursor sol total mass.

The medium containing the inorganic precursor agent is generally an acidic medium, said acidic character of the medium being obtained by adding, for example, a mineral acid, generally HCl or an organic acid such as acetic acid, preferably HCl.

The pore-forming agent of the precursor sol may be an amphiphilic or a non-amphiphilic pore-forming agent. Generally, it is an organic compound. It may be used either alone or in admixture with other pore-forming agents.

Non amphiphilic pore-forming agents to be suitably used in the present invention include:
synthetic polymers such as polyethylene oxide, having a molecular mass ranging from 50000 to 300000, and polyethylene glycol, having a molecular mass ranging from 50000 to 300000,
gamma-cyclodextrin, lactic acid, and other biological materials such as proteins or sugars such as D-glucose or maltose.

The pore-forming agent is preferably an amphiphilic compound of the surfactant type. One of the main characteristics of such a compound is its ability to form micelles in a solution, subsequently to the solvent evaporation which concentrates the solution, leading to the formation of a mineral matrix-based mesostructured film. It thus acts as a structuring agent.

Surfactants may be non ionic, cationic, anionic or amphoteric. These surfactants are for most of them commercially available.

Ionic surfactants include sodium dodecylbenzene sulfonate, ethoxylated fatty alcohol sulfates, cetyl trimethylammonium bromide (CTAB), cetyl trimethylammonium chloride (CTAC), sodium dodecylsulfate (SDS), and azobiscyanopentanoic acid.

Non ionic surfactants include ethoxylated fatty alcohols, ethoxylated acetylene diols, compounds of the block copolymer type comprising both hydrophilic and hydrophobic blocks, poly(alkylenoxy)alkyl-ethers and surfactants comprising a sorbitan group.

Amongst the block copolymer type surfactants, three-blocks are preferably used, wherein a polyalkylene oxide hydrophobic block having an alkylene oxide moiety comprising at least three carbon atoms, such as a polypropylene oxide block, is linearly and covalently bonded at both ends thereof to a polyalkylene oxide hydrophilic block, such as a polyethylene oxide block, or two-block type copolymers wherein, for example, a polyethylene oxide block is linearly and covalently bonded to a polybutylene oxide or a polypropylene oxide block. Suitable examples thereof include polyoxyethylene-polyoxypropylene-polyoxyethylene (PEO-PPO-PEO) such as those described by Zhao and al. in J. Am. Chem. Soc. 1998, 120, 6024-6036, or those marketed by BASF under the trade name PLURONIC®, noted (EO)ₓ—(PO)_{y}-(EO)_{z}, or HO(CH₂CH₂O)ₓ—(CH₂CH(CH₃)O)_{y}—(CH₂CH₂O)_{z}H, or polyoxyethylene-polyoxybutylene-polyoxyethylene (PEO-PBO-PEO) noted (EO)ₓ-(BO)_{y}-(EO)_{z} or HO(CH₂CH₂O)ₓ—(CH₂CH(CH₃CH₂)O)_{y}—(CH₂CH₂O)_{z}H, or branched PEO-PPO block copolymers marketed by BASF under the trade name TETRONIC®, which are tetrafunctional block copolymers resulting from the sequential addition of propylene oxide and ethylene oxide on ethylene diamine. In the hereabove formulas, x and z are preferably higher than 5, y is preferably higher than 20.

Specific examples of the hereabove compounds include PE6800 of formula (EO)₇₃-(PO)₂₈-(EO)₇₃ and PE10400 of formula (EO)₂₇-(PO)₆₁-(EO)₂₇, Tetronic 908 (also named Poloxamine 908), and Pluronic F68, F77, and F108. Three-block copolymers in a reversed order as compared to those hereabove described may also be used, for example PPO-PEO-PPO three-block copolymers.

Amongst the poly(alkylenoxy)alkyl-ether type surfactants, the poly(ethylenoxy)alkyl-ethers of general formula CₙH₂ₙ₊₁(OCH₂CH₂)ₓOH are preferred, especially those wherein n ≧12 and x≧8, for example the surfactants marketed by ICI under the trade name BRIJ®, such as BRIJ 56® (C₁₆H₃₃(OCH₂CH₂)₁₀OH), BRIJ 58® (C₁₆H₃₃(OCH₂CH₂)₂₀OH) and BRIJ 76® (polyoxyethylene (10) stearyl ether or C₁₈H₃₇(OCH₂CH₂)₁₀OH).

Amongst the surfactants comprising a sorbitan group, the surfactants marketed by ICI under the trade name TWEEN®, which are polyoxyethylene sorbitans esterified by fatty acids, or the surfactants marketed by Aldrich Chem. Co. under the trade name SPAN®, whose sorbitan head has been esterified by fatty acids, may be used.

Preferred pore-forming agents are CTAB and ethylene oxide and propylene oxide two-block or three-block copolymers, preferably three-block copolymers. CTAB is the most preferred pore-forming agent.

Generally speaking, the pore-forming agent represents from 2 to 10% as related to the precursor sol total mass.

One of the drawbacks of such mesoporous films having a matrix comprising only inorganic precursor agents such as hereabove described is their poor stability under a highly humid atmosphere. These films tend to become charged with water as time goes by, what modifies their initial properties.

The stability of the mesoporous or mesostructured film optical properties is a particularly important question if those have to be used in the optical field, because, in opposition to semiconductor field applications, wherein dielectric coefficient variations within predetermined limits may be considered without affecting the semiconductor functioning, very small temporal variations of the refractive index have an immediately perceptible consequence in the optical field, for example by modifying the coating colours and performances.

For providing mesoporous films (or coatings) having an improved stability over time, in particular for applications in the optical field, and more specifically in ophthalmic optics, it is possible to prepare a film comprising a matrix having a hydrophobic character, especially so that water cannot enter therein. These films will be simply called “films having a hydrophobic matrix” hereafter.

As opposed to films having a matrix based on silica or on another metal or metalloid which does not bear any hydrophobic group, these films having a hydrophobic matrix are preferred.

As used herein, “hydrophobic” groups are intended to mean atom combinations which can not associate with water molecules, especially through hydrogen bonding. Such groups are generally organic, non polar groups, without any charged atoms. Alkyl, phenyl, fluoroalkyl, and (poly)fluoro alkoxy[(poly)alkylenoxy] alkyl groups, and hydrogen atoms, therefore belong to this class.

According to the invention, the hydrophobic character of the film may be obtained by means of two different methods, or of a combination of both methods.

The first hydrophobation method implies introducing at least one hydrophobic precursor agent bearing at least one hydrophobic group into the precursor sol, prior to the step of depositing the precursor sol film.

The second hydrophobation method implies treating the film subsequently to the deposition step c) or, if present, subsequently to the consolidation step d), with at least one hydrophobic reactive compound bearing at least one hydrophobic group.

As hereabove indicated, it is possible to combine both these hydrophobation methods, that is to say to introduce at least one hydrophobic precursor agent bearing at least one hydrophobic group into the precursor sol before the step of depositing the film of the precursor sol, then to treat the film subsequently to the deposition step or, if present, subsequently to the consolidation step, with at least one hydrophobic reactive compound bearing at least one hydrophobic group. Said hydrophobic reactive compound is necessarily different from said hydrophobic precursor agent. In this case, post-treating the film having a hydrophobic matrix with a second hydrophobic compound is intended to improve the hydrophobic character of the film.

The first hydrophobation method will first be described. In this embodiment, the inorganic precursor agent and the hydrophobic precursor agent are the two precursor agents of the film matrix, whose walls will enclose the mesopores in the final mesoporous film.

The hydrophobic precursor agent is preferably selected from compounds and mixtures of compounds of formula (II) or (III):

(R¹)ₙ₁(R²)ₙ₂M (II)

or

(R³)ₙ₃(R⁴)ₙ₄M-R′-M(R⁵)ₙ₅(R⁶)ₙ₆ (III)

wherein:
M is a tetravalent metal or metalloid, for example Si, Sn, Zr, Hf or Ti, and preferably silicon;
R¹, R³ and R⁵, being the same or different, are saturated or unsaturated, preferably C₁-C₈ and more preferably C₁-C₄, hydrocarbon hydrophobic groups, for example alkyl groups, such as methyl or ethyl groups, vinyl groups, aryl groups, for example phenyl groups, optionally substituted, especially by one or more C₁-C₄ alkyl groups or are fluorinated or perfluorinated analogous groups of the previously mentioned hydrocarbon groups, for example fluoroalkyl or perfluoroalkyl groups, or (poly)fluoro or perfluoro alkoxy[(poly)alkylenoxy]alkyl groups. Preferably R¹, R³ and R⁵ are methyl groups.
R², R⁴ and R⁶, being the same or different, are hydrolyzable groups, preferably selected from —O—R alkoxy groups, in particular C₁-C₄ alkoxy groups, or —O—C(O)R acyloxy groups, where R is an alkyl radical, preferably a C₁-C₆ alkyl radical, preferably a methyl or ethyl radical, and halogens such as Cl, Br and I. Said groups are preferably alkoxy groups, especially methoxy or ethoxy groups, and more preferably ethoxy groups.
R′ is a divalent group, for example a linear or branched, optionally substituted, alkylene group, an optionally substituted cycloalkylene group, an optionally substituted arylene group, or a combination of the previously mentioned groups of the same class and/or of different classes, especially cycloalkylene alkylene, biscycloalkylene, biscycloalkylene alkylene, arylene alkylene, bisphenylene and bisphenylene alkylene groups. Preferred alkylene groups include linear C₁-C₁₀ alkylene groups, for example methylene group —CH₂—, ethylene group —CH₂—CH₂—, butylenes and hexylene groups, especially 1,4-butylene and 1,6-hexylene groups, and branched C₃-C₁₀ alkylene radicals such as 1,4-(4-methyl pentylene), 1,6-(2,2,4-trimethyl hexylene), 1,5-(5-methyl hexylene), 1,6-(6-methyl heptylene), 1,5-(2,2,5-trimethyl hexylene), 1,7-(3,7-dimethyl octylene), 2,2-(dimethylpropylene) and 1,6-(2,4,4-trimethyl hexylene) radicals. Preferred cycloalkylene radicals include cyclopentylene and cyclohexylene radicals, optionally substituted especially with alkyl groups. R′ is preferably a methylene, an ethylene or a phenylene group.
n₁ is an integer ranging from 1 to 3, n₂ is an integer ranging from 1 to 3, n₁+n₂=4,
n₃, n₄, n₅, and n₆ are integers ranging from 0 to 3 provided that the sums of n₃+n₅ and n₄+n₆ are different from zero, and n₃+n₄=n₅+n₆=3.

Preferred hydrophobic precursor agents include alkyl alkoxysilanes, especially alkyl trialkoxysilanes such as methyl triethoxysilane (MTEOS, CH₃Si(OC₂H₅)₃), vinyl alkoxysilanes, especially vinyl trialkoxysilanes such as vinyl triethoxysilane, fluoroalkyl alkoxysilanes, especially fluoroalkyl trialkoxysilanes such as 3,3,3-trifluoropropyl trimethoxysilane of formula CF₃CH₂CH₂Si(OCH₃)₃ and aryl alkoxysilanes, especially aryl trialkoxysilanes. Dialkyl dialkoxysilanes may also be used, such as dimethyl diethoxysilane. Methyl triethoxysilane (MTEOS) is the particularly preferred hydrophobic precursor agent.

Generally speaking, the mole ratio of the hydrophobic precursor agent to the inorganic precursor agent does vary from 10:90 to 50:50, more preferably from 20:80 to 45:55, and is preferably equal to 40:60, especially when using MTEOS as the hydrophobic precursor agent in the precursor sol.

Generally, the hydrophobic precursor agent bearing at least one hydrophobic group represents from 1 to 50% by mass as related to the precursor sol total mass and the mass ratio of the pore-forming agents to both the inorganic precursor agents and the hydrophobic precursor agents bearing at least one hydrophobic group optionally added to the precursor sol, does vary from 0.01 to 5, preferably from 0.05 to 1.

The hydrophobic precursor agent bearing at least one hydrophobic group may be dissolved in the precursor sol of the mesoporous film, or introduced into this precursor sol in the form of a solution in an organic solvent.

A particularly recommended method for making the precursor sol of a mesoporous film according to this first embodiment of the invention is a method for incorporating the precursor agents in two steps, comprising a first step of pre-hydrolysis and condensation, generally in the presence of an acid catalyst, of the inorganic precursor agent such as previously defined (forming what will be called a “silica sol” when the inorganic precursor agent is a silica precursor), followed with a second step of admixing the hydrophobic precursor agent, with an optionally simultaneous introduction of the pore-forming agent.

Such a two-step hydrolysis advantageously enables to introduce high amounts of the hydrophobic precursor agent and to reach a mole ratio of the hydrophobic precursor agent to the inorganic precursor agent as high as 50:50, while preserving an ordered structure within the film.

The hydrolysis is conducted in an acidic medium, by adding water to a pH value generally lower than 4, more preferably lower than 2, and most often between 1 and 2.

During the first step, the hydrolysis of the inorganic precursor compound is preferably performed in the presence of a slight excess of water. When using an inorganic precursor agent of formula (I), a water amount which is 1 to 1.5 times the water molar amount required for a stoichiometric hydrolysis of the compound M(X)₄ hydrolyzable moieties is generally used. The reaction is then allowed to proceed (sol aging). During this procedure, the sol is preferably maintained at a temperature of about 50 to 70° C., generally of 60° C., for 30 minutes to 2 hours. Condensation may also be conducted at lower temperatures, but with longer condensation time periods.

Yet preferably, quickly after the hydrophobic precursor agent has been introduced into the precursor sol, preferably within 5 minutes or less, and more preferably within two minutes or less subsequent to the hydrophobic precursor agent introduction into the precursor sol, should the precursor sol be deposited and the precursor sol film be formed. Working within this very short time period enables to minimize the condensation reaction of the hydrophobic precursor agent prior to depositing and forming the film. In other words, a partial hydrolysis of the hydrophobic precursor agent is simply induced without causing any significant formation of condensed species from this agent.

The second hydrophobation method according to the invention will now be described. In this embodiment of the invention, a step of treating the film with at least one hydrophobic reactive compound bearing at least one hydrophobic group is conducted after the deposition step or, if present, after the consolidation step.

Treating the film with the hydrophobic reactive compound or the mixture of hydrophobic reactive compounds is conducted, according to the invention, preferably by contacting the hydrophobic reactive compound or the mixture of hydrophobic reactive compounds in a liquid or a vapor state, preferably in a vapor state, with said film. In a liquid phase, the hydrophobic reactive compound may be advantageously dissolved in or diluted with a solvent and this solution may be brought to reflux, the film to be treated having been previously dipped therein. It is also possible to work at room temperature by treating the film with ultrasounds during the step of treating said film with the one or more hydrophobic reactive compounds, for example by dipping the substrate coated with the film to be treated in an ultrasound reactor containing the hydrophobic reactive compound or the mixture of hydrophobic reactive compounds.

If using a silica-based matrix comprising silanol groups, the hydrophobic reactive compound is reactive against silanol groups and a treatment with this compound leads to a silica matrix, at least part of the silanol groups of which has been derivatized to hydrophobic groups. It is possible to use the hydrophobic reactive compound in a large excess as compared to the number of silanol groups to be grafted, in order to accelerate the reaction.

In a first alternative method, this additional step, called “post-synthetic grafting”, is conducted during the step of removing the pore-forming agent. This alternative method is particularly suitable when this removal step is a solvent extraction step. Thus, both treatments may be combined using a solution of a hydrophobic reactive agent bearing at least one hydrophobic group in an extraction solvent of the pore-forming agent.

In a second alternative method, the post-synthetic grafting additional step is conducted subsequently to the step of removing the pore-forming agent. This embodiment which implies treating a mesoporous film, is known from the literature and has been especially described in the patent applications US 2003/157311 and WO 99/09383.

In a third alternative method, the post-synthetic grafting additional step is conducted before the step of removing the pore-forming agent.

When the coating of the invention is a multilayered coating, the post-synthetic grafting step is common to all the layers forming said coating.

Hydrophobic reactive compounds bearing at least one hydrophobic group which are particularly suitable in the present invention are compounds based on a tetravalent metal or metalloid, preferably silicon, comprising only one function which is able to react with the film residual hydroxyl groups, in particular a Si—Cl, Si—NH—, or Si—OR function, where R is an alkyl group, preferably a C₁-C₄alkyl group.

Preferably, said hydrophobic reactive compound is selected from compounds and mixtures of compounds of formula (IX):

(R¹)₃(R²)M (IX)
wherein:
M is a tetravalent metal or metalloid, for example Si, Sn, Zr, Hf or Ti, preferably silicon.
the R¹ groups, being the same or different, are saturated or unsaturated, preferably C₁-C₈ and more preferably C₁-C₄, hydrocarbon hydrophobic groups, for example alkyl groups, such as methyl or ethyl groups, vinyl groups, aryl groups, for example phenyl groups, optionally substituted, especially by one or more C₁-C₄ alkyl groups, or are fluorinated or perfluorinated analogous groups of the previously mentioned hydrocarbon groups, for example fluoroalkyl or perfluoroalkyl groups, or (poly)fluoro or perfluoro alkoxy[(poly)alkylenoxy]alkyl groups. Preferably, R¹ is a methyl group.
R² is a hydrolyzable group, preferably selected from an —O—R alkoxy group, in particular a C₁-C₄ alkoxy group, or an —O—C(O)R acyloxy group, where R is an alkyl radical, preferably a C₁-C₆ alkyl radical, preferably a methyl or ethyl radical, an amino group optionally substituted by one or two functional groups, for example by an alkyl or a silane group, and a halogen group such as Cl, Br and I. Said group is preferably an alkoxy group, especially a methoxy or an ethoxy, a chloro or a —NHSiMe₃ group.

Hydrophobic reactive compounds to be advantageously used include fluoroalkyl chlorosilanes, especially a tri(fluoroalkyl)chlorosilane or a fluoroalkyl dialkyl chlorosilane such as 3,3,3-trifluoropropyldimethyl chlorosilane of formula CF₃—CH₂—CH₂—Si(CH₃)₂Cl, alkyl alkoxysilanes, especially a trialkyl alkoxysilane such as trimethyl methoxysilane (CH₃)₃SiOCH₃, fluoroalkyl alkoxysilanes, especially a tri(fluoroalkyl)alkoxysilane or a fluoroalkyl dialkyl alkoxysilane, alkyl chlorosilanes, especially a trialkyl chlorosilane such as trimethyl chlorosilane, trialkyl silazanes or hexaalkyl disilazanes.

In a preferred embodiment, the hydrophobic reactive compound comprises a trialkylsilyl group, preferably a trimethysilyl group, and a silazane group, in particular a disilazane group. 1,1,1,3,3,3-hexamethyl disilazane (CH₃)₃Si—NH—Si(CH₃)₃, noted HMDS, is the particularly preferred hydrophobic reactive compound.

In the present invention, the additional step of post-treatment with said hydrophobic reactive compound is preferably conducted at a temperature ≦150° C., preferably ≦130° C., more preferably ≦120° C. and even more preferably ≦110° C.

Optionally, the coating having an index profile according to the invention may comprise, as an inner layer (the closest to the substrate), a layer of a non mesoporous material such as silica, having a thickness ranging from 1 to 100 nm. This additional layer may provide an improvement of the performances of said coating, especially by minimizing its average reflection factor.

The step c) of depositing the precursor sol film onto the substrate main surface (or onto the hereabove described non mesoporous additional layer) may be performed using any traditional method, such as for example immersion deposition, spray deposition or spin coating, preferably spin coating. Preferably, deposition step c) is performed under an atmosphere having a relative humidity (RH) varying from 40 to 80%.

The structure of the deposited precursor sol film may optionally be consolidated during a consolidation step, which consists in optionally completing the removal of the solvent or mixture of organic solvents from the precursor sol film and/or of the possible water excess and in carrying condensation on, for example of the residual silanol groups which are included in the sol if using a silica-based matrix, generally by heating said film. Such a heat treatment enables to increase the polymerization degree of the silica lattice. The consolidation step is preferably performed by heating at a temperature ≦150° C., preferably ≦130° C., more preferably ≦120° C. and even more preferably ≦110° C.

At the end of this polymerization step leading to a composite material, a substrate coated with a precursor film of a mesoporous film will be obtained, that is to say coated with a film which will lead to a mesoporous film, once the pore-forming agent will be at least partially removed.

According to the invention, either only one precursor film of a mesoporous film, or a multilayered coating comprising a stack of several precursor films of mesoporous films, may be deposited onto the substrate.

The removal of the pore-forming agent which is included within a film produces a mesoporous film, having air-filled pores, whose refractive index is lower than the one of the initial film.

Thus, using a sol comprising tetraethoxysilane as an inorganic precursor agent and CTAB as a pore-forming agent, in a CTAB/TEOS mole ratio equal to 0.10, a mesostructured film of the hexagonal 3d type structure is produced, whose refractive index is of about 1.48. The refractive index after removal of the surfactant depends on the chosen removal method, but does generally range from 1.22 to 1.29 for such a CTAB/TEOS mole ratio, and is typically of about 1.25. A mesoporous film having a hydrophobic matrix may have a refractive index of the same order.

Preferably, the removal of the pore-forming agent is performed by any suitable method enabling to work at low temperatures, that is to say at temperatures ≦150° C., preferably ≦130° C., more preferably ≦120° C. and even more preferably ≦110° C.

The first method of the invention is preferably implemented with substrates coated with a coating comprising either only one precursor film of a mesoporous film, or several of these films having the same composition.

In step e), the pore-forming agent is partially removed from at least part of the coating comprising the film deposited in step c) so as to create in said part of the coating a refractive index gradient which is perpendicular to the surface of the substrate underlying said part of the coating and directed towards the surface of said coating which is the closest to the substrate.

In the present application, a removal of the pore-forming agent from at least part of the coating means that at least part of the external surface of the coating (which will be referred to as a “localized area” of the coating) is submitted to the removal treatment. This localized treatment may affect either one layer (film) of the coating or several layers of the coating in the case of a multilayered coating. The localized areas of the coating surface affected by the removal treatment may have sizes as small as 0.1 to 200 μm.

In the present application, partially removing the pore-forming agent means that this one is removed until a certain depth of the coating, and that the final coating will have a thickness from which the pore-forming agent will not have been removed. The removal treatment may affect part of or the whole external surface of the coating.

The implemented partial removal methods produce such a removal front that the coating thickness affected by the removal is substantially the same in the whole part of the article which has been submitted to the removal.

In the practice, the partial removal of the pore-forming agent may be performed by a controlled degradation of the same, for example by plasma-assisted oxidation, for example with an oxygen or an argon plasma, or by ozone oxidation, ozone being for example generated by an UV-lamp, by corona discharge, or by light-irradiation photodegradation.

Those methods make it possible to degrade the pore-forming agent at temperatures which are close to the room temperature, by diffusing species until the expected depth within the precursor coating of the mesoporous coating, so that a pore-forming agent concentration gradient is created.

As the removal of the pore-forming agent firstly affects the external part of the film, the same will have a lower refractive index than the inner part of the film, which will not have undergone any removal process, whatever the removal method used. A monotone and continuous pore-forming agent concentration profile is thus obtained within said part of the coating, and therefore a monotone and continuous refractive index profile, that is to say a refractive index gradient which is perpendicular to the surface of the substrate underlying said part of the coating and directed towards the substrate. A SIMS assay (Secondary Ion Mass Spectrometry) enables to obtain the concentration profile by determining a depth distribution profile of each element (Si, O, C . . . ), as well as the RBS method (Rutherford Backscattering Spectrometry).

Depending on the way the removal of the pore-forming agent is conducted, two categories of mesoporous coatings having a refractive index profile may be obtained: i) the pore-forming agent has been removed until a certain depth from at least one localized area of the coating: at least one localized area of the coating is thus mesoporous until a certain depth of said coating; ii) the pore-forming agent has been removed until a certain depth from the whole coating: the whole coating is thus mesoporous until a certain depth of said coating.

Scenario ii) corresponds to the most preferred embodiment of the first method of the invention.

At the end of step e), a substrate is thus recovered, having a main surface covered with a coating, part of which at least is mesoporous, and whose refractive index profile results from the fact that the pore-forming agent has only been partially removed from the coating.

The second method of the invention requires to prepare a stack of at least two precursor films of a mesoporous film which are optionally structured (what is generally the case when the pore-forming agent is of the amphiphilic type). Indeed, the refractive index profile of the final article results from the way this stack has been created, in the context of this second method. Preferably, the coating obtained in this embodiment of the invention comprises a three-layer stack.

Step e) of this second method is therefore a step of depositing onto the film resulting from the previous step a film of a sol comprising at least one inorganic precursor agent, at least one pore-forming agent, at least one organic solvent, water and optionally a catalyst for hydrolyzing the inorganic precursor agent, these components being such as hereabove defined, but provided that the pore-forming agent represents a higher percentage of the precursor sol total mass as compared to that of the pore-forming agent in the precursor sol used to make the film obtained in the previous step.

This second deposited film may optionally be consolidated in a step f), and, in an optional step g), the sequence of the deposition steps e) and the consolidation steps f) may be repeated at least once if a mesoporous coating comprising at least three layers is expected, but provided that in each step e), the pore-forming agent represents a higher percentage in the precursor sol total mass as compared to that of the pore-forming agent in the precursor sol used to make the film obtained in the previous step. Optionally, the deposited stack undergoes a final curing step to complete the polymerization, at a temperature ≦150° C., preferably ≦130° C., more preferably ≦120° C. and even more preferably ≦110° C.

During step h), the pore-forming agent is removed at least partially from at least part of the coating comprising the films deposited in steps c), e) and if present, g), producing a substrate having a main surface covered with a multilayered coating, part of which at least is mesoporous and has a refractive index profile decreasing away from the substrate along any axis which is perpendicular to the surface of the substrate underlying said mesoporous part of said coating.

As is the case of the first presented method, the removal of the pore-forming agent firstly affects the external layers of the multilayered coating, that is to say the layers which are the most distant from the substrate, and lastly the inner layers of the multilayered coating, that is to say the layers which are the closest to the substrate, whatever the removal method used.

Depending on the way the removal of the pore-forming agent is conducted, four categories of mesoporous coatings having a refractive index profile may be obtained: i) the pore-forming agent has been removed from the whole volume filled by the coating: the whole volume filled by the coating is therefore mesoporous; ii) the pore-forming agent has been removed along the whole depth of at least one localized area of the coating: at least one localized area of the coating is therefore mesoporous along the whole depth of said coating; iii) the pore-forming agent has been removed until a certain depth from at least one localized area of the coating; iv) the pore-forming agent has been removed until a certain depth from the whole coating.

As opposed to the first method, the refractive index profile obtained in the coating is not a continuous profile, but a discontinuous profile. In particular, an index profile is obtained, gradually varying in the mesoporous part of the coating corresponding to scenarios i) and ii).

In the embodiments iii) and iv), the pore-forming agent is preferably removed until such a depth that only the inner film of the coating, that is to say the film which is the closest to the substrate, is not affected by the removal or only to a certain thickness.

However, several deposited films may be not affected by the removal process.

Scenarios i) and iv) correspond to the two preferred embodiments of the second method of the invention.

It should be noted that in the embodiments i) and ii), the refractive index profile only results from the fact that the multilayered coating has been created by depositing films increasingly charged with pore-forming agents, while in the embodiments iii) and iv), the refractive index profile results on the one hand from the fact that the multilayered coating has been created by depositing films increasingly charged with pore-forming agents, and on the other hand from the fact that the pore-forming agent is only partially removed from the coating.

The methods for partially removing the pore-forming agent (corresponding to the hereabove scenarios iii) and iv)) which may be implemented in the second method of the invention are the same as those already described in the context of the first method.

On the contrary, the methods for removing the pore-forming agent which may be implemented in the scenarios i) and ii) of the second method of the invention are said to be “total removal methods”. In the present invention, a pore-forming agent is said to have been totally removed in a portion of the coating volume when the pore-forming agent total mass initially included in this volume has been preferably reduced by at least 90%, more preferably by at least 95% and even more preferably by at least 99%.

The total removal methods include for example calcination, if the substrate is appropriate, or the well known extraction methods using a solvent or a supercritical fluid. Degradation methods may also be implemented, for example by a plasma-assisted oxidation, for example with an oxygen or an argon plasma, or by ozone oxidation, ozone being for example generated by an UV-lamp, by corona discharge, or by light-irradiation photodegradation. The latter method is especially described in the patent application US 2004/0151651. An extraction using a supercritical fluid (typically supercritical CO₂) of a surfactant included within a mesostructured material is performed for example in the patent JP 2000-226572.

Preferably, the removal of the pore-forming agent is performed by extraction in the scenario i) of the second method of the invention. Several successive extractions may be performed, so as to obtain the expected extraction degree.

Preferably, the extraction does use an organic solvent or a mixture of organic solvents, by dipping the article coated with the formed and optionally consolidated coating in a solvent or a mixture of solvents, preferably organic solvents, heated to a temperature ≦150° C. A reflux solvent will be preferably used. Any solvent having a boiling point ≦150° C., preferably ≦130° C., more preferably ≦120° C. and even more preferably ≦110° C. may be suitable. Preferred solvents include alkanols, in particular ethanol (boiling point=78° C.) or isopropanol (boiling point=80-83° C.), alkyl ketones, in particular acetone (boiling point=56° C.) and chloroalkanes such as dichloromethane or chloroform. A non toxic solvent such as acetone or ethanol will be preferably used. Acetone is particularly well suited for the removal by solubilization of surfactants of the CTAB or CTAC type. Solvent extraction may also be efficiently performed at room temperature, using ultrasounds, optionally under stirring.

It should be noted that extracting the pore-forming agent by means of an organic solvent makes it possible to better control the final thickness of the mesoporous film as would be the case with calcination.

The obtained films in the scenarios i) and ii) are highly porous (void fraction of about 55%). They comprise both well calibrated mesopores, of 4 nm diameter (micellar imprinting), and micropores of a few angstroms diameter, located within the matrix walls, and a priori non monodispersed. As regards the porous morphology of the various films, mesopores generally represent ⅔ of the void volume and micropores generally represent ⅓ of the void volume, what could be determined by submitting the film to adsorption experiments.

FIG. 1 schematically shows the morphology of a silica matrix-based mesoporous film obtained after having at least locally removed the pore-forming agent. Two mesopores, separated from each other by microporous silica walls, are shown on the figure.

According to the methods of the invention, the mesoporous part of the final coating may be ordered or not. As previously stated, an amphiphilic pore-forming agent is preferably used, which acts as a structuring agent, so that the mesoporous part of the final coating does generally have an ordered structure. Generally speaking, a structured film has better mechanical properties, and the means for controlling the reproducibility of its production process are easier.

As used herein, “an ordered or organized structure” is intended to mean a structure having a periodic organization in a thickness of at least 20 nm, and in an area of at least 20 nm in size, preferably of 300 nm in size, in the plane of the deposited layer.

Said ordered structure may especially be of the hexagonal 3d, cubic or hexagonal 2d type, at least locally. The hexagonal 3d structure is composed of spherical micelles arranged into a lattice similar to a compact hexagonal stack. Its space group is P6₃/mmc. The cubic structure (space group Pm3n) is composed of ellipsoidal and spherical micelles. The hexagonal 2d structure (space group c2m) is composed of cylinder-shaped micelles.

FIG. 2 appended to the present application shows part of the ternary phase diagram of TEOS/MTEOS/CTAB films. It does illustrate the ordered structures (phases) which may be obtained in the final gel from a sol comprising these three components, depending on their mole ratio values.

When the MTEOS/TEOS mole ratio does reach a threshold value higher than 1, the films may not be structured anymore. When the MTEOS/TEOS mole ratio is lower than this threshold value, the mesoporous film according to the present invention may have an organized structure of the hexagonal 3d, cubic or hexagonal 2d type, depending on the CTAB amount used. The phase-delimiting CTAB/TEOS mole ratio values do increase as the MTEOS/TEOS mole ratio values do increase.

For example, when the pore-forming agent is CTAB, the inorganic precursor agent is TEOS and the hydrophobic precursor agent is MTEOS (introduced into the precursor sol prior to the deposition step), given a MTEOS/TEOS mole ratio=1, the result is:

a hexagonal 3d type ordered structure for 0.210≦(CTAB/TEOS)≦0.280;

a cubic type ordered structure for 0.297≦(CTAB/TEOS)≦0.332;

a hexagonal 2d type ordered structure for 0.350≦(CTAB/TEOS)≦0.385.

Preferably, the amounts of both precursor agents and of the pore-forming agent are selected in the sol preparation steps so that the mesoporous films obtained according to the methods of the invention have a hexagonal 3d type ordered structure.

In their final state, the coatings deposited according to both methods of the invention generally have a maximum thickness of about 1 μm, and more generally a thickness ranging from 50 to 500 nm.

The present invention may be applied in a number of articles: optical fibers, optical lenses, in particular ophthalmic lenses, especially spectacle glasses, guided optics (optical waveguides), diffraction networks, Bragg mirrors, insulants for microelectronics, filtration membranes and chromatography stationary phases, this list being of course non limitative.

If the article has a particular symmetry, for example an axial, radial or spherical refractive index profile may be obtained.

In the case of an axial profile, the index varies in a given direction, in the case of a radial profile, the index varies depending on the distance to a given axis, in the case of a spherical profile, the index varies depending on the distance to a given point.

In the particular case where the index profile is one of a gradient (GRIN), an axial gradient implies that the index is homogeneous in any plane which is perpendicular to the axis direction; a radial gradient implies that the index is homogeneous on any cylinder-shaped surface of a given radius and of the same axis as the gradient; a spherical refractive index gradient implies that the iso-index surfaces are spherical in shape. An axial or a radial profile may especially be obtained in the case of optical fibers.

The mesoporous coating having an index profile according to the invention may advantageously be used in optics, because it is an achromatic, antireflective coating. It makes it possible to provide articles, especially transparent articles, having higher antireflective properties as compared to those having a traditional antireflective coating of the interferential type, because the average reflection factor of the coating of the invention does less vary with the wavelength, what makes this antireflective coating type more resistant to small thickness or index variations.

In the present application, the “average reflection factor” is such as defined in the ISO 8980-4 standard, that is to say it is the average reflection factor in the visible region between 400 and 700 nm, noted Rₘ.

Preferably, the average reflection factor in the visible region (400-700 nm) of an article coated according to the invention is lower than 2%, more preferably lower than 1% and even more preferably lower than 0.75%.

Moreover, the silica mesoporous structures, comprising or not a pore-forming agent of the surfactant type, do have a good mechanical strength.

The article of the invention is preferably an optical lens, more preferably an ophthalmic lens, or a blank of an optical or ophthalmic lens. As previously explained, the substrate of the article may comprise one or more functional coatings, and the coating having a refractive index profile of the invention may be deposited onto any of them, especially onto an abrasion-resistant and/or scratch-resistant coating.

The mesoporous coating having a refractive index profile according to the invention may optionally be coated with coatings intended to modify its surface properties, such as a hydrophobic and/or oleophobic layer (anti-fouling top coat) whose thickness is generally lower than 10 nm, preferably ranging from 1 to 10 nm, more preferably from 1 to 5 nm.

These hydrophobic and/or oleophobic coatings are well known from the state of the art and are generally obtained by means of traditional thermal evaporation methods. They are generally produced from fluorosilicones or fluorosilazanes, that is to say fluorine atom-containing silicones or silazanes.

Fluorosilanes which are particularly well adapted to form hydrophobic and/or oleophobic coatings are those having fluoropolyether moieties, which are described in the patent U.S. Pat. No. 6,277,485.

These fluorosilanes have the following general formula:

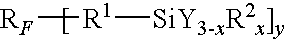

wherein R_{F} is a monovalent or divalent polyfluoropolyether group, R¹ is an alkylene or arylene divalent group or a combination thereof, optionally comprising one or more heteroatoms or functional groups, and optionally substituted by halogens, and having preferably from 2 to 16 carbon atoms; R² is a lower alkyl group (that is to say a C₁-C₄ alkyl group); Y is a halogen atom, a lower alkoxy group (that is to say a C₁-C₄ alkoxy group, preferably a methoxy or ethoxy group), or a lower acyloxy group (that is to say a —OC(O)R³ group, where R³ is a C₁-C₄ alkyl group); x is equal to 0 or 1; and y is equal to 1 (R_{F} is a monovalent group) or 2 (R_{F} is a divalent group). Suitable compounds generally have a number average molecular mass of at least 1000. Preferably, Y is a lower alkoxy group and R_{F} is a perfluoropolyether group.

Other recommended fluorosilanes are those having the following formulae:

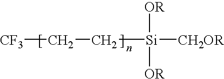

where n=5, 7, 9 or 11, and R is an alkyl group, preferably a C₁-C₁₀ alkyl group such as —CH₃, —C₂H₅ and —C₃H₇;

CF₃(CF₂)₅CH₂CH₂Si(OC₂H₅)₃ ((tridecafluoro-1,1,2,2-tetrahydro)octyl-triethoxysilane);

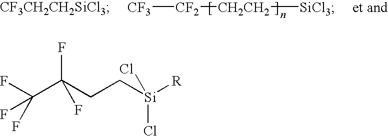

where n=7 or 9, and R is such as hereabove defined.

Compositions containing fluorosilanes which are also recommended for making hydrophobic and/or oleophobic coatings are described in the patent U.S. Pat. No. 6,183,872. They comprise fluoropolymers having organic moieties bearing silicon-based groups illustrated by the following general formula and having a molecular mass ranging from 5.10² to 1.10⁵:

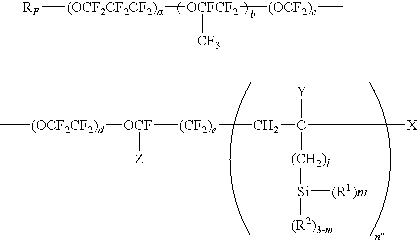

wherein R_{F} is a perfluoroalkyl moiety; Z is a fluoro or trifluoromethyl group; a, b, c, d and e each are, independently from one another, 0 or an integer higher or equal to 1, provided that the sum of a+b+c+d+e is not lower than 1 and that the order of the recurrent units given into the brackets indexed under a, b, c, d and e is not limited to that represented; Y is H or an alkyl group comprising from 1 to 4 carbon atoms; X is a hydrogen, bromine or iodine atom; R¹ is a hydroxyl group or a hydrolyzable group; R² is a hydrogen atom or a monovalent hydrocarbon group; l is equal to 0, 1 or 2; m is equal to 1, 2 or 3; and n″ is an integer at least equal to 1, preferably at least equal to 2.

A preferred hydrophobic and/or oleophobic coating composition is marketed by the Shin-Etsu Chemical company under the trade name KP 801M®. Another preferred hydrophobic and/or oleophobic coating composition is marketed by the Daikin Industries company under the trade name OPTOOL DSX®. It is a fluorinated resin comprising perfluoropropylene groups.

When possible, the substrate onto which is formed the mesoporous coating having a refractive index profile according to the invention may also be a temporary substrate, onto which said coating is stored, waiting for a transfer onto a definitive substrate such as a substrate for an ophthalmic lens.

Said temporary substrate may be rigid or flexible, preferably flexible. It is a removable substrate, i.e. intended to be removed once the transfer of the mesoporous coating onto the definitive substrate has been performed.

The temporary substrate may be used having been beforehand coated with a layer of a mold release agent intended to make the transfer easier. This layer may optionally be removed at the end of the transfer step.

Flexible temporary substrates are generally fine elements of a few millimeters thick, preferably between 0.2 and 5 mm thick, more preferably between 0.5 and 2 mm thick, made of a plastic material, preferably a thermoplastic material.

Examples of thermoplastic (co)polymers to be suitably used for making temporary substrates are polysulfones, aliphatic poly(meth)acrylates, such as methyl poly(meth)acrylate, polyethylene, polypropylene, polystyrene, SBM (styrene-butadiene-methyl methacrylate) block copolymers, polyphenylene sulfide (PPS), arylene polyoxides, polyimides, polyesters, polycarbonates, such as bisphenol A polycarbonate, polyvinyl chloride, polyamides, such as nylons, as well as copolymers and mixtures thereof. Polycarbonate is the preferred thermoplastic material.

The temporary substrate main surface may comprise a stack of one or more functional coatings (already described) which will be transferred together with the mesoporous coating of the invention onto the definitive substrate. Of course, the coatings to be transferred have been deposited onto the temporary substrate in reverse order as related to the desired stacking order on the definitive substrate.

When the substrate onto which the film of the precursor sol is deposited during step c) of the methods of the present invention is a temporary substrate, the invention further relates to a method for transferring the mesoporous coating having a refractive index profile (or the stack of coatings comprising said mesoporous coating) from the temporary substrate onto a definitive substrate. Methods of the invention then comprise the following additional step consisting in:
z) transferring said mesoporous coating from the temporary substrate onto a definitive substrate.

Transferring the coating(s) present on the temporary substrate may be performed according to any suitable method known from the man skilled in the art.

Rather than to transfer, it is also possible to bond to the definitive substrate the mesoporous coating having a refractive index profile previously formed on a temporary substrate.

The hereunder examples do illustrate the present invention without limitation. All the refractive indices herein are expressed at λ=633 nm and T=20-25° C.

### EXAMPLES

### Reactants and Materials Used for the Synthesis of the Mesoporous Films Having a Refractive Index Profile

TEOS of formula Si(OC₂H₅)₄ has been used as an inorganic precursor agent, MTEOS of formula CH₃Si(OC₂H₅)₃ has been used as a hydrophobic precursor agent and CTAB of formula C₁₆H₃₃N⁺(CH₃)₃, Br⁻ has been used as a pore-forming agent.

Sols have been prepared using absolute ethanol as an organic solvent and dilute hydrochloric acid (so as to obtain a pH value of 1.25) as a hydrolysis catalyst.

The optical article used in examples 1, 2, 5 and 6-9 comprises a substrate for an ORMA® lens from ESSILOR (refractive index=1.50) coated with the abrasion-resistant and/or scratch-resistant coating disclosed in the patent FR 2702486 (refractive index=1.48 and thickness=3.5 μm), comprising GLYMO, DMDES, colloidal silica and aluminum acetylacetonate. In examples 6-9, the substrate coated with the abrasion-resistant varnish has been submitted to a preparative surface treatment (alkaline etching) prior to depositing the mesoporous coating of the invention.

The optical article used in examples 3 and 4 comprises a substrate of the “Nikon 1.67” type (n=1.656 at 635 nm) coated with a 3.5 μm-thick coating having a refractive index equal to 1.593.

The refractive index of the mesoporous layers is measured at 632.8 nm by ellipsometry. Their thickness is obtained by means of a profilometer.

### A) First Method of the Invention

The preparation of the precursor sol of a mesoporous film according to the first method of the invention is a method of incorporating the precursor agents in two steps. During the first step, a silica sol comprising the inorganic precursor agent is prepared. The hydrophobic precursor agent is incorporated into this sol during a second step.

### 1. General Procedure for Preparing the Silica Sol

The silica sol is prepared by hydrolyzing TEOS, then by condensing part of it by heating for 1 h at 60° C. in a medium composed of ethanol and dilute hydrochloric acid, in a flask provided with a refrigerant. The mole ratios of the silica sol components are as follows: TEOS/(absolute) ethanol/HCl—H₂O=1:3.8:5.

The prepared silica sol is composed of polymer small aggregates of partially condensed silica, comprising a large amount of silanol functions. These do disappear in part if a hydrophobic precursor agent such as MTEOS is introduced into the sol. This synthesis has thus been conceived so that the whole {silica polymer aggregates+MTEOS} remains sufficiently hydrophilic so as not to alter the system hydrophilic-hydrophobic balance. Indeed, polymerized MTEOS is hydrophobic, as opposed to hydrolyzed and non condensed MTEOS. The synthesis has also been conceived so as to preserve the reactivity of the silica aggregates (more precisely, their gelling rate), which is generally altered by the presence of MTEOS.

### 2. General Procedure for Depositing and Consolidating a MTEOS-TEOS Matrix-Based Mesostructured Film of the Invention (MTEOS/TEOS Mole Ratio=40:60)

A stock solution of 48.7 g of CTAB per liter of ethanol is prepared. Dissolution may be made easier using ultrasounds for a couple of seconds. 6.7 mL thereof are collected, then 0.75 mL of pure MTEOS are added thereto. 3 mL of the silica sol hereabove prepared are transferred into a flask dipped in an ice bath at 0° C. and enriched with 67 μl of acidified water (HCl pH=1.25). The whole is then added under stirring to the CTAB/ethanol/MTEOS mixture. 90 seconds later, a few drops of the thus prepared mixture are deposited onto the ORMA® substrate from ESSILOR coated with the abrasion-resistant and/or scratch-resistant coating (example 1) or onto the Nikon 1.67 substrate (example 3), both hereabove described, which is then rotated at 3000 rpm for 2 minutes (acceleration of about 2000 rpm/s). The deposition is performed in a chamber flushed through with a strong nitrogen flow and whose atmosphere has a relative humidity RH equal to 51% at T=20-25° C. The obtained film, whose thickness measured by UV-visible ellipsometry is of about 260 nm (example 1) or of about 407 nm (example 3), has a hexagonal 3d type ordered structure.

The thus obtained substrate coated with the mesostructured film is then consolidated by heating to 110° C. for 12 h.

### 3. General Procedure for the Partial Removal of the CTAB Surfactant

Oxygen or argon plasma: the substrate coated with the mesostructured film is placed in a chamber provided with two electrodes which may generate a plasma. Once vacuum has been created within the chamber, the gas is introduced and the plasma is generated (the gas flow may be maintained or not, and the pressure within the chamber is monitored). After the plasma exposure, the chamber content is pumped out before recovering the substrate.

UV-ozone degradation method: the substrate coated with the mesostructured film is placed in a chamber provided with a lamp which may generate wavelengths suitable for converting oxygen to ozone (185 and 214 nm). The chamber is placed under an air or oxygen atmosphere (controlled pressure), then the lamp is turned on. After the ozone exposure, the chamber content is pumped out before recovering the substrate.

### 4. Performance Evaluation of the Coating of the Invention

### a) Examples 1 and 2

The reflection curve of an article whose mesoporous layer has an index profile obeying a decreasing square-law function limited by 1.47 and 1.25 (example 1) is relatively achromatic. Its average reflection factor in the visible region Rₘ is equal to 1.19%.

A more efficient coating (example 2) may be obtained by depositing onto the substrate coated with the abrasion-resistant and/or scratch-resistant coating hereabove described a 20 nm-thick silica layer having a refractive index equal to 1.45, then a 100 nm-thick mesoporous coating having a refractive index decreasing with a quasi-linear profile from 1.32 to 1.26 away from the substrate (using a CTAB content different from that of § 2). The reflection curve of such an article is achromatic. Its average reflection factor in the visible region (400-700 nm) is equal to 0.55%, what is excellent.

### b) Examples 3 and 4

The reflection curve of an article whose mesoporous layer has a refractive index profile obeying a decreasing square-law function limited by 1.479 and 1.248 (example 3) is not achromatic. Its average reflection factor in the visible region Rₘ is equal to 1.24%. The maximum of the curve being reached between 500 and 550 nm (2.8%), the ocular sensitivity-weighted average reflection factor (Rᵥ, from 380 to 780 nm) is high, having a maximum ocular sensitivity at 550 nm.

These conclusions also apply when the mesoporous layer has an index profile obeying a linear, exponential or logarithmic function, having less interesting average reflection factor values.

A more efficient coating (example 4) may be obtained by depositing onto the Nikon 1.67 substrate coated with a 3.5 μm-thick coating having a refractive index equal to 1.50, a 20 nm-thick silica layer having a refractive index equal to 1.45, then a 100 nm-thick mesoporous coating having a refractive index decreasing quasi-linearly from 1.32 to 1.26 away from the substrate (using a CTAB content different from that of § 2). The reflection spectrum of such an article is quasi-achromatic. Its average reflection factor in the visible region (400-700 nm) is equal to 0.42%, what is excellent. The ocular sensitivity-weighted average reflection factor (Rᵥ, from 380 to 780 nm) is also very low.

Examples 3 and 4 demonstrate that the mesoporous coating having a refractive index profile of the invention may also be suitably used for substrates having a high refractive index such as the “Nikon 1.67” substrate.

B) Second method of the invention

### Example 5

### a) Preparing a Multilayered Precursor Coating of a Mesoporous Coating

The same materials and reactants are used, while varying the precursor sol CTAB content so as to prepare a three-layered mesostructured coating comprising, after an at least partial removal of CTAB (films being described from the substrate to the air):

a 244 nm-thick film having a refractive index equal to 1.429.

a 52 nm-thick film having a refractive index equal to 1.288.

a 68 nm-thick film having a refractive index equal to 1.250.

### b) General Procedure for Totally Removing the CTAB Surfactant

CTAB is removed by extraction by dipping the substrate coated with the coating prepared in § 1 in reflux acetone (56° C.) for 2 h. CTAB may also be solubilized by dipping in reflux ethanol (78° C.) for 5 hours. The removal of CTAB may be followed by FTIR spectroscopy after the coated substrate has been removed from the mixture and has been rinsed a few minutes in acetone.

### c) Performance Evaluation of the Coating of the Invention

The reflection curve of such an article (example 5) is achromatic. Its average reflection factors Rₘ and Rᵥ in the visible region are equal to 0.47% and 0.42%, respectively. This mesoporous coating having a gradually varying refractive index profile is therefore at least as valuable as the commercially available interferential stacks.

### Examples 6-9

### a) Preparing Mesoporous Coatings

In examples 6-9, the prepared mesoporous coatings are three-layered coatings, whose refractive index profile gradually varies. They are obtained by successively depositing onto the substrate three layers comprising an increasing amount of the pore-forming agent, so that, once the latter has been removed, the obtained coating has a refractive index profile decreasing from the substrate to the air. Each coating layer comprises a TEOS matrix having undergone a hydrophobation treatment with HMDS after the pore-forming agent has been removed from the whole volume filled by the three-layered coating (all the volume filled by said coating is therefore mesoporous).

Due to the reactants used, the mesoporous coating layers have refractive indices which may vary from a maximum value of about 1.46 (for example with a CTAB/Si mole ratio equal to 0.025) to a minimum value of about 1.3135 when the CTAB/Si mole ratio is equal to 0.10.

### Example 6

A solution of 0.0343 g of CTAB per mL of absolute ethanol is prepared. Dissolution of CTAB is made easier using ultrasounds. 10 mL of the silica sol such as prepared in § A)1 (once back to room temperature) are added to 5 mL of said CTAB solution. The first layer is deposited by spin-coating at a rate of 1000 rpm, in a relative humidity of 45-50%, at a temperature between 18 and 20° C., and is submitted to a consolidation step (heat treatment: 15 min. precuring at 65° C.) prior to depositing the subsequent layer. The second layer (20 mL of the silica sol are added to 60 mL of a 0.0137 g/mL CTAB solution in absolute ethanol, followed with the addition of 80 mL absolute ethanol), and then the third layer (10 mL of the silica sol are added to 42 mL of a 0.0137 g/mL CTAB solution in absolute ethanol, followed with the addition of 8 mL absolute ethanol) are deposited according to a procedure similar to that used for the first layer, but with a spin-coating rate of 3000 rpm. The stack is submitted to a polymerization final step at 100° C. for 3 h.

At this stage, a three-layered mesostructured coating is obtained. CTAB, localized inside the mesopores, is then washed out by dipping the substrate coated with the three-layered mesostructured coating for 15 minutes in an ultrasound reactor (ultrasound delivery system), trademark Elmasonic, comprising isopropanol, at room temperature. The ultrasound homogeneity is ensured by turning the “sweep” function of the apparatus on. At the end of this step, a mesoporous coating is obtained, the three layers of which are then made hydrophobic, so as to stabilize their refractive index against water vapour, by dipping the substrate coated with the mesoporous coating for 15 minutes in an ultrasound reactor, trademark Elmasonic, containing HMDS, at room temperature. The ultrasound homogeneity is ensured by turning the “sweep” function of the apparatus on. The glasses are then rinsed with isopropylic alcohol in order to remove HMDS in excess. The properties and the synthesis parameters of the coating are given in table 1:

TABLE 1

| | | Refractive index | CTAB/Si | Spin- |
|---|---|---|---|---|
| Example 6 | Thickness | (at 632.8 nm) | mole ratio | coating rate |
| first layer* | 400 nm | 1.462 | 0.025 | 1000 rpm |
| second layer | 65 nm | 1.446 | 0.060 | 3000 rpm |
| third layer | 90 nm | 1.336 | 0.085 | 3000 rpm |

*First layer deposited onto the substrate.

### Example 7

The mesoporous three-layered coating of example 7 is prepared in the same way as in example 6. The first and second layers of the coating of example 7 are the same as those of the coating of example 6. The third layer is different (10 mL of the silica sol are added to 50 mL of a 0.0137 g/mL CTAB solution in absolute ethanol; thickness: 100 nm). The properties and the synthesis parameters of the coating are given in table 2:

TABLE 2

| | | Refractive index | CTAB/Si | Spin- |
|---|---|---|---|---|
| Example 7 | Thickness | (at 632.8 nm) | mole ratio | coating rate |
| first layer | 400 nm | 1.462 | 0.025 | 1000 rpm |
| second layer | 65 nm | 1.446 | 0.060 | 3000 rpm |
| third layer | 100 nm | 1.323 | 0.100 | 3000 rpm |

### Example 8

The mesoporous three-layered coating of example 8 is prepared in the same way as in example 6. It comprises a first layer (10 mL of the silica sol are added to 12 mL of a 0.0343 g/mL CTAB solution in absolute ethanol), a second layer (15 mL of the silica sol are added to 48.5 mL of a 0.0137 g/mL CTAB solution in absolute ethanol, followed with the addition of 56 mL absolute ethanol) and a third layer (10 mL of the silica sol are added to 42 mL of a 0.0137 g/mL CTAB solution in absolute ethanol, followed with the addition of 8 mL absolute ethanol). The properties and the synthesis parameters of the coating are given in table 3:

TABLE 3

| | | Refractive index | CTAB/Si | Spin- |
|---|---|---|---|---|
| Example 8 | Thickness | (at 632.8 nm) | mole ratio | coating rate |
| first layer | 490 nm | 1.446 | 0.06 | 1000 rpm |
| second layer | 59 nm | 1.389 | 0.065 | 3000 rpm |
| third layer | 90 nm | 1.336 | 0.085 | 3000 rpm |

### Example 9

The mesoporous three-layered coating of example 9 is prepared in the same way as in example 8. The first and second layers of the coating of example 9 are the same as those of the coating of example 8. The third layer is different (10 mL of the silica sol are added to 50 mL of a 0.0137 g/mL CTAB solution in absolute ethanol; thickness: 100 nm). The properties and the synthesis parameters of the coating are given in table 4:

TABLE 4

| | | Refractive index | CTAB/Si | Spin- |
|---|---|---|---|---|
| Example 9 | Thickness | (at 632.8 nm) | mole ratio | coating rate |
| first layer | 490 nm | 1.446 | 0.06 | 1000 rpm |
| second layer | 59 nm | 1.389 | 0.065 | 3000 rpm |
| third layer | 100 nm | 1.323 | 0.10 | 3000 rpm |

### b) Measurement of the Optical Properties of the Prepared Mesoporous Coatings

The mesoporous three-layered coatings of examples 6 to 9 are antireflective coatings. For each of these examples, the variations vs. wavelength of the reflection coefficient of the final optical article on its side coated with the mesoporous coating are illustrated on FIGS. 3 to 6 respectively (For each figure: upper part curve: before removal of the pore-forming agent; lower part curve: after removal of the pore-forming agent and grafting with HMDS). Table 5 gives the following optical parameters of these optical articles: the average reflection factor in the visible region Rₘ, the ocular sensitivity-weighted average reflection factor Rᵥ, the hue angle h, and the chroma value C*.

TABLE 5

| | Rₘ (%) | Rᵥ (%) | h (°) | C* |
|---|---|---|---|---|
| Example 6 | 1.65 | 1.64 | 291 | 1.1 |
| Example 7 | 1.61 | 1.53 | 269 | 4.6 |
| Example 8 | 1.69 | 1.61 | 298 | 3.9 |
| Example 9 | 2.00 | 1.80 | 267 | 6.9 |

It can be observed for each of the examples 6 to 9 that the reflection curve is very “flat”, which demonstrates the achromatic behavior of the reflection coefficient (i.e. a minor wavelength dependence).

1.-34. (canceled)

35. An article comprising a substrate having a main surface covered with a coating at least part of which coating is mesoporous, wherein the mesoporous part of said coating comprises a refractive index profile with optical function with variation imposed by mesopore content and/or filling ratio of the mesopores.

36. The article of claim 35, wherein the refractive index variation is monotone, decreasing along any axis which is perpendicular to the surface of the substrate underlying the mesoporous part of said coating and oriented away from the substrate.

37. The article of claim 35, wherein the mesoporous coating comprising a refractive index profile has a thickness ranging from 50 to 500 nm.

38. The article of claim 35, further defined as an optical fiber or optical lens.

39. The article of claim 35, further defined as having an average reflection factor in the visible region Rm of lower than 2%.

40. The article of claim 39, further defined as having an average reflection factor in the visible region Rm of lower than 0.75%.

41. The article of claim 35, wherein the coating comprising a refractive index profile comprises a silica-based matrix comprising silanol groups.

42. The article of claim 41, wherein at least part of the silanol groups have been derivatized to hydrophobic groups by reacting with a hydrophobic reactive compound.

43. The article of claim 35, wherein the coating has a hydrophobic matrix.

44. The article of claim 35, wherein the refractive index profile gradually varies.

45. The article of claim 35, wherein the whole volume filled by the coating comprising a refractive index profile is mesoporous.

46. The article of claim 35, wherein at least one localized area of the coating comprising a refractive index profile is mesoporous until a certain depth of said coating.

47. The article of claim 35, wherein the whole coating comprising a refractive index profile is mesoporous until a certain depth of said coating.

48. The article of claim 35, wherein at least one localized area of the coating comprising a refractive index profile is mesoporous along the whole depth of said coating.

49. A method for making an article of claim 35, comprising:
a) providing a substrate;
b) preparing a precursor sol of a mesoporous film comprising at least one inorganic precursor agent, at least one pore-forming agent, at least one organic solvent, and water;
c) depositing a film of the precursor sol prepared in the previous step onto a main surface of the substrate;
d) removing the pore-forming agent from at least part of the coating comprising the film deposited in step c);
e) recovering a substrate having a main surface covered with a coating, part of which at least is mesoporous;
wherein in step d), the pore-forming agent is partially removed from at least part of the coating comprising the film deposited in step c) so as to create in said part of the coating a refractive index gradient which is perpendicular to the surface of the substrate underlying said part of the coating and directed towards the surface of said coating which is closest to the substrate.

50. The method of claim 49, wherein the inorganic precursor agent is of formula:
M(X)₄ (I)
wherein M is a tetravalent metal or metalloid and the X groups independently are hydrolysable groups.

51. The method of claim 50, wherein M is Ti, Zr, Hf, Sn or Si.

52. The method of claim 50, wherein the X groups are independently alkoxy, acyloxy, or halogen groups.

53. The method of claim 49, wherein the pore-forming agent is cetyl trimethylammonium bromide, cetyl trimethylammonium chloride, ethylene oxide and a propylene oxide three-block copolymer, ethylene oxide and a propylene oxide two-block copolymer, or poly(ethylenoxy)alkyl-ethers.

54. The method of claim 49, further comprising a step of introducing at least one hydrophobic precursor agent bearing at least one hydrophobic group into the precursor sol before the step of depositing the film of the precursor sol.

55. The method of claim 49, wherein the precursor sol further comprises a catalyst capable of hydrolyzing the inorganic precursor agent.

56. The method of claim 49, further comprising consolidating the film deposited in steps c) and d).

57. The method of claim 56, further comprising a step of treating the film subsequent to the deposition step, or, if present, subsequent to the consolidation step, with at least one hydrophobic reactive compound bearing at least one hydrophobic group, provided that, if a hydrophobic precursor agent bearing at least one hydrophobic group has been introduced into the precursor sol, said hydrophobic reactive compound is different from said hydrophobic precursor agent.

58. The method of claim 49, further defined as comprising at least the following steps:
a) providing a substrate;
b) preparing a precursor sol of a mesoporous film comprising at least one inorganic precursor agent, at least one pore-forming agent, at least one organic solvent, and water;
c) depositing a film of the precursor sol prepared in the previous step onto a main surface of the substrate;
d) depositing onto the film resulting from the previous step a precursor sol of a mesoporous film comprising at least one inorganic precursor agent, at least one pore-forming agent, at least one organic solvent, and water;
e) removing the pore-forming agent at least partially from at least part of the coating comprising the films deposited;
f) recovering a substrate having a main surface covered with a multilayered coating, part of which at least is mesoporous and has a refractive index profile decreasing away from the substrate along any axis which is perpendicular to the surface of the substrate underlying said mesoporous part of said coating;
wherein in step d), the pore-forming agent represents a higher percentage of the precursor sol total mass as compared to that of the pore-forming agent in the precursor sol used to make the film obtained in the previous step.

59. The method of claim 58, wherein the precursor sol further comprises a catalyst capable of hydrolyzing the inorganic precursor agent.

60. The method of claim 58, further comprising consolidating the film deposited in steps c) and d).

61. The method of claim 60, further comprising a step of treating the film subsequent to the deposition step, or, if present, subsequent to the consolidation step, with at least one hydrophobic reactive compound bearing at least one hydrophobic group, provided that, if a hydrophobic precursor agent bearing at least one hydrophobic group has been introduced into the precursor sol, said hydrophobic reactive compound is different from said hydrophobic precursor agent.

62. The method of claim 58, further comprising repeating step d) at least once, wherein, in each step d), the pore-forming agent represents a higher percentage of the precursor sol total mass as compared to that of the pore-forming agent in the precursor sol used to make the film obtained in the previous step.

63. The method of claim 58, wherein the inorganic precursor agent is of formula:
M(X)₄ (I)
wherein M is a tetravalent metal or metalloid and the X groups independently are hydrolysable groups.

64. The method of claim 63, wherein M is Ti, Zr, Hf, Sn or Si.

65. The method of claim 63, wherein the X groups are independently alkoxy, acyloxy, or halogen groups.

66. The method of claim 58, wherein the pore-forming agent is cetyl trimethylammonium bromide, cetyl trimethylammonium chloride, ethylene oxide and a propylene oxide three-block copolymer, ethylene oxide and a propylene oxide two-block copolymer, or poly(ethylenoxy)alkyl-ethers.

67. The method of claim 58, further comprising a step of introducing at least one hydrophobic precursor agent bearing at least one hydrophobic group into the precursor sol before the step of depositing the film on the precursor sol.

68. The method of claim 67, wherein all the steps thereof are conducted at a temperature ≦150° C.

69. The method of claim 68, wherein all the steps thereof are conducted at a temperature ≦110° C.

70. The method of claim 58, wherein the removal of the pore-forming agent is performed by degradation, oxygen plasma-assisted oxidation, argon plasma-assisted oxidation, by ozone oxidation, corona discharge, or light-irradiation photodegradation calcination, solvent extraction, or supercritical fluid extraction.

71. The method of claim 58, wherein the pore-forming agent has been removed from the whole volume filled by the coating.

72. The method of claim 58, wherein the pore-forming agent has been removed along the whole depth of at least one localized area of the coating.

73. The method of claim 49, wherein the hydrophobic precursor agent is selected from compounds and mixtures of compounds of formula (II) or (III):
(R¹)ₙ₁(R²)ₙ₂M (II)
or
(R¹)ₙ₃(R⁴)ₙ₄M-R′-M(R′)ₙ₅(R⁵)ₙ₆ (III)
wherein:
M is a tetravalent metal or metalloid;
R¹, R³ and R⁵, independently, are saturated or unsaturated and substituted or unsubstituted hydrocarbon hydrophobic group or fluorinated or perfluorinated analogous groups of said hydro carbon hydrophilic groups;
R², R⁴ and R⁶, independently, are hydrolysable groups;
R′ is a divalent group;
n₁ is an integer ranging from 1 to 3, n₂ is an integer ranging from 1 to 3, n₁+n₂=4; and
n₃, n₄, n₅, and n₆ are integers ranging from 0 to 3 provided that the sums of n₃+n₅ and n₄+n₆ are different from zero, and n₃+n₄=n₅+n₆=3.

74. The method of claim 73, wherein M is Si, Sn, Zr, Hf or Ti.

75. The method of claim 73, wherein said hydrocarbon hydrophobic groups are alkyl, vinyl, or aryl groups.

76. The method of claim 73, wherein said hydrolysable groups are alkoxy groups, —O—C(O)R acyloxy groups where R is a C₁-C₆ alkyl radical, and/or halogens.

77. The method of claim 73, wherein R′ is an alkylene or arylene group.

78. The method of claim 73, wherein the mole ratio of the hydrophobic precursor agent to the inorganic precursor agent varies from 10:90 to 50:50.

79. The method of claim 78, wherein the mole ratio of the hydrophobic precursor agent to the inorganic precursor agent is equal to 40:60.

80. The method of claim 49, further comprising a step of treating the film subsequent to the deposition step, or, if present, subsequent to the consolidation step, with at least one hydrophobic reactive compound bearing at least one hydrophobic group, provided that, if a hydrophobic precursor agent bearing at least one hydrophobic group has been introduced into the precursor sol, said hydrophobic reactive compound is different from said hydrophobic precursor agent.

81. The method of claim 80, wherein the step of introducing said hydrophobic reactive compound is conducted before, after or during the step of removing the pore-forming agent.

82. The method of claim 80, wherein the hydrophobic reactive compound is of formula (IX):
(R¹)₃(R²)M (IX)
wherein:
M is a tetravalent metal or metalloid;
the R¹ groups, independently, are saturated or unsaturated hydrocarbon hydrophobic groups; and
R² is a hydrolysable group.

83. The method of claim 82, wherein M is Si, Sn, Zr, Hf or Ti.

84. The method of claim 82, wherein said hydrocarbon hydrophobic groups are methyl, ethyl, vinyl, and/or aryl groups.

85. The method of claim 82, wherein said hydrolysable groups are alkoxy groups, —O—C(O)R acyloxy groups in which R is an alkyl radical, substituted or unsubstituted amino groups, and/or halogens.

86. The method of claim 82, wherein the hydrophobic reactive compound is a trialkylchlorosilane, a trialkylalkoxysilane, a fluoroalkyl alkoxysilane, a fluoroalkyl chlorosilane, a trialkylsilazane, or a hexaalkyldisilazane.

87. The method of claim 80, wherein a treatment of the film with ultrasounds is conducted during the step of treating said film with at least one hydrophobic reactive compound bearing at least one hydrophobic group.

88. The method of claim 49, wherein all the steps thereof are conducted at a temperature ≦150° C.

89. The method of claim 88, wherein all the steps thereof are conducted at a temperature ≦110° C.

90. The method of claim 49, wherein the partial removal of the pore-forming agent is performed by controlled degradation, oxygen plasma-assisted oxidation, argon plasma-assisted oxidation, by ozone oxidation, corona discharge, or light-irradiation photodegradation.

91. The method of claim 49, wherein the pore-forming agent has been removed until a certain depth from at least one localized area of the mesoporous coating comprising a refractive index profile.

92. The method of claim 49, wherein the pore-forming agent has been removed until a certain depth from the whole coating.
